(19) United States
(12) Patent Application Publication
(10) Pub. No.: US 2004/0210352 A1
(43) Pub. Date: Oct. 21, 2004

(54) Method for optimising the desing of motor drive sections

(76) Inventors: Thomas Bayer, Igersheim (DE); Manfred Wittenstein, Bad Mergentheim (DE)

Correspondence Address: BACHMAN & LAPOINTE, P.C., 900 CHAPEL STREET, SUITE 1201, NEW HAVEN, CT, 06510, US

(21) Appl. No.: 10/474,973

(22) PCT Filed: Feb. 8, 2002
(86) PCT No.: PCT/EP02/01319

(30) Foreign Application Priority Data
Apr. 20, 2001 (DE) 101 20 943.6

(51) Int. Cl. G06F 7/00

(52) U.S. Cl. 701/1

(57) ABSTRACT

The invention relates to a method for optimizing the design of motor drive sections with the aid of a computer which is provided with storage means and which is used to calculate the parameters of drive components using a predefinable set of data which represents the load to which the drive components are subjected. The invention is characterised in that the set of data used to calculate the parameters is automatically determined, taking into account real load data which is collected by corresponding sensors on installed and operational drive sections and which is electrically transferred to the computer unit.

### BACKGROUND OF THE INVENTION

The invention relates to a method for optimization of the design of motor drive paths.

In the case of known methods, motor drive paths, such as the drive unit for a machine tool, are designed by means of an electronic computation system which has a memory unit. The computation system uses a data record which is predetermined and represents the load on the drive components as the basis for calculating the parameters for the drive components, for example the motor power, the sizes of the bearings for the drive shaft, the transmission ratio of a transmission which is connected to the motor, etc.

The performance and the life of the drive path which is implemented in accordance with the design and is in operation is dependent on the match between the actual load data and the data record for the load of the drive components, which is generally predetermined by the operator of the drive path. By way of example, the operator stipulates that the drive path will be used 24 hours a day on a three-shift basis, and that the motor components will be switched on and off on fixed clock cycles. The manufacturer of the drive path uses this as the basis for designing, for example, the motor power or motor cooling for the drive components. If the predetermined data record does not match the actual load data, this leads to increased maintenance effort for the drive path, or even to premature failure.

The invention is based on the object of providing a method for optimization of the design of motor drive paths, which overcomes the disadvantages of the prior art and, in particular, the method according to the invention is intended to ensure optimum design of the drive paths for the actual loads in operation, thus increasing the life of the drive path and/or reducing the maintenance effort.

### SUMMARY OF THE INVENTION

The object is achieved by the present invention by providing a for optimization of the design of motor drive paths having a computation system, with memory means for calculation of parameters of drive components using a data record which can be predetermined and which represents the load on the drive components, characterized in that the data record which is used for the calculation of the parameters is recorded by means of appropriate sensors, including actual, installed drive paths which are in operation, and load data which is transmitted electronically to the computation system is determined automatically.

Since actual load data for installed drive paths which are in operation is recorded by means of appropriate sensors and is transmitted electronically to the computation system, and since the data record which is used for calculation of the parameters is determined automatically including the recorded actual load data, this ensures that the design of the drive path is based as accurately as possible on the data corresponding to the actual load situation. The load data is in this case transmitted continuously or at regular time intervals, which can be predetermined and/or are event-based, for example in the form of digital data which, if necessary, is coded and thus cannot be read by unauthorized persons.

The drive paths according to the invention in this case include in particular drive paths for industrial systems, such as production machines, packaging machines, tools, etc, as well as drive paths of a general nature such as those in land vehicles, aircraft and surface vessels or in wind energy systems. Actual data include, for example, the torque acting on the output drive shaft or on the input drive shaft, the bearing forces that occur, the ambient temperature, the air humidity in the environment, the lubricant filling level, the lubricant temperature, the seal provided by the seals, etc. In this case, both the time profile of these variables and their maximum and minimum values are preferably recorded by means of appropriate sensors. The recording process can be carried out over individual work cycles, days, weeks and months or even over the entire life of the drive path or of the manufacturing facility in which the drive path is integrated. In particular, it is possible in any case to store continuously the signals which are supplied from some or from all of the sensors for a time period which can be predetermined, for example 10 minutes, in a type of drive-path or operating data plotter in order in this way to make it possible, for example, to reconstruct what has happened in the final minutes before an event when machine damage or an accident occurs, and thus, if required, to make it possible to determine the cause of the event. The determined values may be transmitted directly by electronic means to the computation system, or may be temporarily stored, displayed and/or read indirectly or directly on the drive path while it is in operation.

The motor drive path can also be designed using the method according to the invention such that, for example, the evaluation of the actual load data makes it possible to determine whether specific drive components are loaded to a greater or lesser extent than average, and whether corresponding loads can be emitted to other drive components or can be transferred from them. For example, in the case of a multiple axis robot, a required movement path can be provided in a different way and, in particular, including different drive components. If it is found that a specific drive component is so severely loaded for a specific drive moment that this specific drive component limits the overall life of the drive path and hence of the robot, this specific drive movement can be provided by the inclusion of other drive components, which are less highly loaded. This correction or optimization can be carried out on an installed drive path, if necessary even during operation of the drive path, and/or when designing the next drive path for the same application, or for a comparable application. The actual load data is preferably recorded directly on the drive path while automatically determining the data record that is used for calculation of the parameters, and/or the parameters are calculated at a remote point, for example in a server computer at the premises of the drive component supplier.

Furthermore, the method according to the invention and the capability to monitor operation associated with it also make it possible, for example, to determine the life or remaining life, the maintenance intervals or the performance reserve of the drive path or of individual drive components, and to guarantee these to the customer. With regard to the determination of the life or remaining life, it is possible to use knowledge relating to damage accumulation from other technical fields, for example from the material customer, as is described in HAIBACH E.: “Modifizlerte lineare Schadensakkumulations-Hypothese zur Berücksichtlgung des Dauerfestigkeitsabfalls mit fortschreitender Schädigung” [Modified linear damage accumulation hypothesis in order to take account of fatigue failure with progressive damage], Technical Reports No. TM 50/70, Darmstadt Laboratory for Fatigue Life 1970. According to this document, it is possible, for example, to use mathematical functions, whose complexity and/or parameters depend on the application, to determine the remaining life of a machine. The damage accumulation hypothesis is in this case based, inter alia, on the fact that a “large disturbance variable” damages a machine, and/or reduces its remaining life, to an (x-times) greater extent than a comparatively “small disturbance variable”.

The computation system for designing the motor drive path and the drive path which is in operation are preferably located at different points. For example, the drive path is located in the operator's manufacturing facility, while the computation system is located at the premises of a manufacturer of the drive path. The electronic transmission of the actual load data takes place electronically, preferably via a data network. The data network may be a public data network, such as the Internet, or a non-public data network, such as an Intranet within a company or a concern. If necessary or advantageous, the data may in any case also be transmitted in sections without the use of wires, for example within the site at which the drive path is used via a wire-free infrared link to a central reception point in the manufacturing workshop, or from the roof of the manufacturing workshop via a terrestrially or satellite-based mobile radio link directly to the premises of the manufacturer of the drive path. Existing national or international mobile telephone networks may also be used for this purpose.

The representative data record at that location in the computation system is preferably determined automatically by linking the actual load data to an original data record which is already stored in the computation system. A computer program which can be predetermined may, for example, may be used for the automatic determination process. The already stored original data record may either be the data record predetermined by the operator of the drive path or a data record which has already been optimized including previously determined actual load data. The previously applicable stored original data record can either be overwritten by the newly calculated representative data record or may be stored, provided with a time stamp, in order to record the history and development of the respectively applicable data records.

The actual load data is preferably linked to the original data record using a weighting function. The weighting function may, for example, be an empirically determined statistical function on the basis of which, for example, a spurious value in the actual load data resulting from a special load on the drive path or from machine damage is not included to an excessively significantly extent in the representative data record on which the design of future drive paths will be based. For example, the weighting function may be a type of low-pass filter function, on the basis of which changing actual load data is not included in the representative data record until after a certain time delay.

The data record that is calculated using the actual load data is preferably individualized or identified on the basis of the origin of the actual load data. This data record can thus be associated with an operator, with a specific type of drive path, with the type of use and/or with the point of use of the drive path, etc. By way of example, a drive path for an operator A for the “packaging machine” type of use at a point of use in “Germany” may result over the course of time when using the method according to the invention in a highly different data record for the load on the drive components than a corresponding drive path for the same operator, with the same type of use, but with a point of use in “Brazil”. A corresponding situation applies, of course, to other types of use and/or to other operators, etc.

The method according to the invention results in a knowledge base being built up at the location of the computation system, which very accurately models with the actual requirements for the drive path and for its drive components as a function of the “type of use”, and “point of use” boundary conditions, etc. The data which is stored in this knowledge base is more applicable than the original data which the operator of these drive paths or of the associated manufacturing facility can inform the manufacturer of the drive paths of in advance. Overall, the method according to the invention leads to an optimum design of the drive path corresponding to the requirements of the respective operator, which are individual in every respect.

Since the actual load data is temporarily stored on the drive path which is in operation and can be displayed and/or read there if required, this data is also directly available to the operator, if required, or, for example, to a servicing technician who is working on the drive path.

The transmission of the temporarily stored actual load data to the computation system may either be controlled by the computation system, for example for the purposes of designing a new drive path, or may be controlled by the drive path, for example at time intervals which can be predetermined, or after a number of load cycles which can be predetermined, etc.

One typical field of application for the method according to the invention is the optimization of the design of drive paths with at least one motor and/or at least one transmission. In many applications, an electric motor is used in this case. Major parameters which govern the wear of an electric motor and/or of a transmission are, for example, the torque that occurs on the shaft, the bearing forces that occur, any tilting moment which may occur, the speed of revolution, the ambient temperature and the winding temperature, etc.

The knowledge base which is built up at the location of the computation system relating to the actually occurring loads and to the parameters that are required as a result of them for the drive components and/or for the automatically determined data record may be transmitted electronically to the operator of the drive path. This is particularly advantageous when this operator is constructing or designing a drive path once again, and for this purpose accesses the computation system that is located at the premises of the manufacturer of the drive path. It is thus possible on the basis of appropriate inputs of the “operator”, “type of use”, “point of use”, etc for the computation system to make a proposal for a more up-to-date data record, which is stored in the computation system, on the basis of the load on the drive components, independently of or as a function of an original data record predetermined by the operator. This more up-to-date data record can be accepted, modified or rejected by the operator. The operator and the computation system preferably communicate via a data network, for example via the Internet. In this case as well, the data may be transmitted both without the use of wires and based on the use of wires. The locations of the computation system, of the operator and/or of the manufacturer of the drive paths may in this case be physically at any distance apart from one another provided that appropriate communication via an electronic data network is in any case possible, at times.

Further advantages, features and details of the invention can be found in the dependent claims and in the following description, in which one exemplary embodiment is described in detail, with reference to the drawings. In this case, the features which are mentioned in the claims and in the description are each significant to the invention individually in their own right and in any given combination.

### BRIEF DESCRIPTION OF THE DRAWINGS

FIG. 1 shows an overview of one possible configuration for the embodiment of the method according to the invention,

FIG. 2 shows a schematic relating to the determination of the representative data record,

FIG. 3 shows a torque profile predetermined by the operator of the drive path,

FIG. 4 shows the associated probability distribution of the switched-on duration,

FIG. 5 shows the associated probability distribution of the pause duration,

FIG. 6 shows the actual torque profile,

FIG. 7 shows the associated probability distribution of the switched-on duration, and

FIG. 8 shows the associated probability distribution of the pause duration.

### DETAILED DESCRIPTION

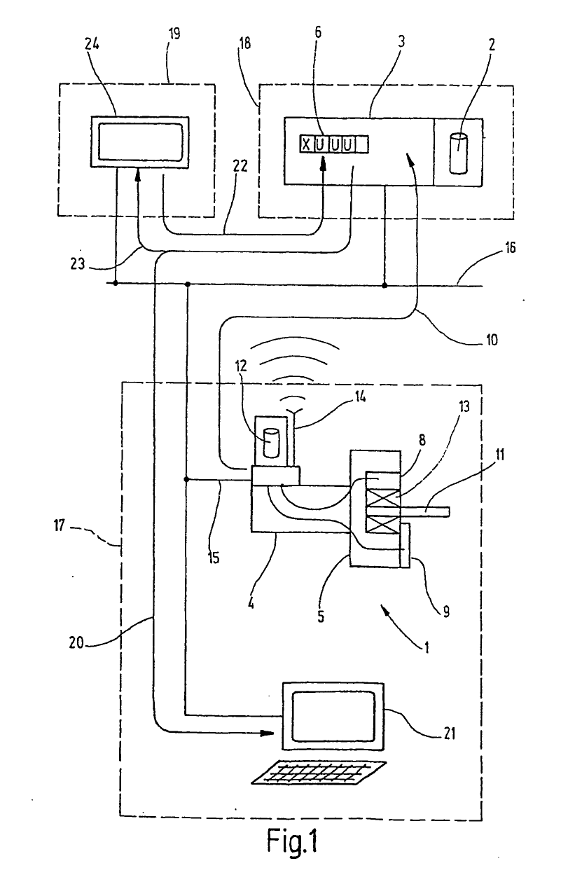

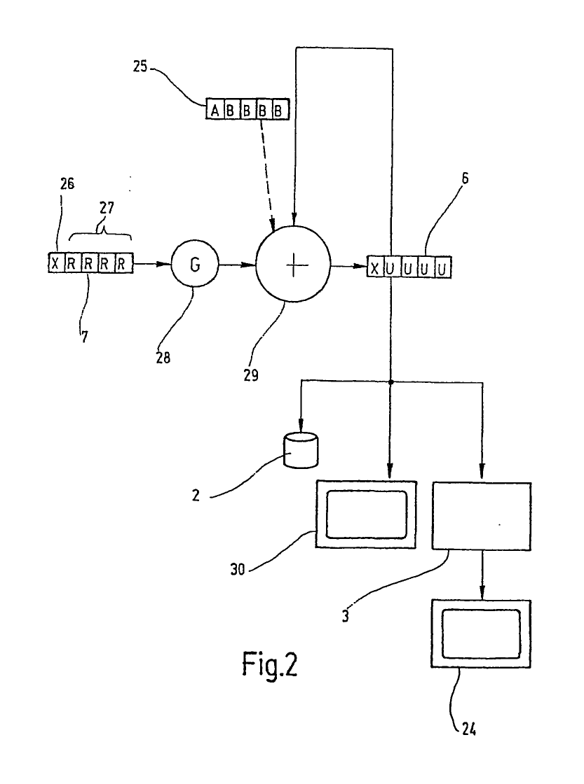

FIG. 1 shows an overview of one possible configuration for the embodiment of the method according to the invention for optimization of the design of motor drive paths 1, with a computation system 3, having a memory means 2, for calculation of parameters for drive components 4, 5 using a data record 6 which can be predetermined and which represents the load on the drive components 4, 5. The actual load data 7 is in this case recorded by means of appropriate sensors 8, 9 on installed drive paths 1 which are in operation, and is transmitted 10 electronically to the computation system 3. The data record 6 which is used for the calculation of the parameters is in this case determined automatically, including the recorded actual load data 7 (see FIG. 2).

The drive path 1 in this case has a motor 4 and a transmission 5. A rotation speed sensor 9 records the rotation speed of the drive shaft 11, and stores these measured values with respect to time in a memory module 12 which is located on the drive path 1. A force sensor 8 which is arranged on the bearing 13 of the drive shaft 11 records the bearing forces that occur over time and/or the torque, and likewise stores these in the memory module 12. This actual load data 7 is transmitted via a mobile radio and/or mobile telephone antenna 14 and/or via a data network connection 15 via a data network 16, for example the Internet, to the computation system 3 which may possibly be physically located a long distance away.

The first location 17, at which the drive path 1 is being operated, is represented by a dashed outline. The second location 18, at which the computation system 3 is located, is likewise represented by a dashed outline. The first location 17 may, for example, be a production workshop of an operator of the drive path 1. The second location 18 may, for example, be the computer center of a manufacturer of the drive path 1.

A third location 19 which, for example, represents the design center of the operator of the drive path 1, is represented by a further dashed outline. The three locations 17, 18, 19 may possibly even be located on three different continents. For example, the second location 18 for manufacture of the drive path 1 may be in Germany, the third location 19 for the design center for the operator of the drive path 1 may be in the USA, and the first location 17 at which the drive path 1 is used may be in Brazil. All three locations 17, 18, 19 are connected to one another electronically, at least temporarily, via the data network 16.

The data which is transmitted 10 from the first location 17 is stored in the memory means 2 at the second location 18, in particular the data record 6 which is determined automatically including the actual load data 7. This data record 6 can then be transmitted back 20 to the first location 17 as well, in order to calculate it, in particular being displayed on a screen 21 there.

This is necessary, for example, when a servicing technician is on site in order to service or to repair the drive path 1.

Furthermore, the data record 6 can be transmitted in response to an appropriate request 22 to the third location 19, in particular being displayed on a further screen 24 there. This is particularly advantageous when a designer with the operator of the drive path 1 at the third location 19 has to design a new drive path for a similar or identical point of use, or type or use etc, and has to design the associated drive components 4, 5. The data record 6 and, in particular, the parameters that have to be calculated using the data record 6 for the drive components 4, 5 then correspond to the actual load situation to be expected.

FIG. 2 shows a schematic relating to the determination of the representative data record 6 by linking the actual load data 7 to an original data record 25 which is already stored in the computation system 3. Initially, this is based on an original data record 25 which was, for example, predetermined by the operator of the drive path 1. The actual load data 7 includes a first data field 26 which identifies and/or individualizes (“X”) the operator, the type of use and the point of use, etc, of the associated drive path 1. The second data field 27 in the actual load data 7 includes the actual load data, such as the torque, bearing force, temperature, etc (“R”), their respective time profiles and/or their minimum and maximum values.

The actual load data 7 is weighted with a weighting function 28, for example as a function of the length of the time period represented by the actual load data 7. The weighted actual load data is then linked 29 to the originally applicable data record 25, 6. In a simplified embodiment, the previously applicable data record 25, 6 may also be replaced by the weighted actual load data 7, or may simply be replaced by the actual load data 7 itself. In many applications, however, it is desirable, for example, for a spurious value in the actual load data 7 resulting from a special load or from the damage to the load path not to be included directly and completely in the representative data record 6. In this case, a type of low-pass filter function by means of the link 29 will be desirable, such that, if an abrupt change occurs in the actual load data 7, the representative data record 6 is matched only gradually to these changed circumstances. The associated time constant with which this matching process is carried out can be predetermined.

The representative data record 6 can be stored in the memory means 2, can be displayed on a screen 30 at the computation system 3, and/or can be passed on to the computation system 3 for calculation of the parameters for the drive components 4, 5. These parameters may then themselves be passed on, for example, to a further screen 24 which may also be installed locally, at a distance from the computation system 3.

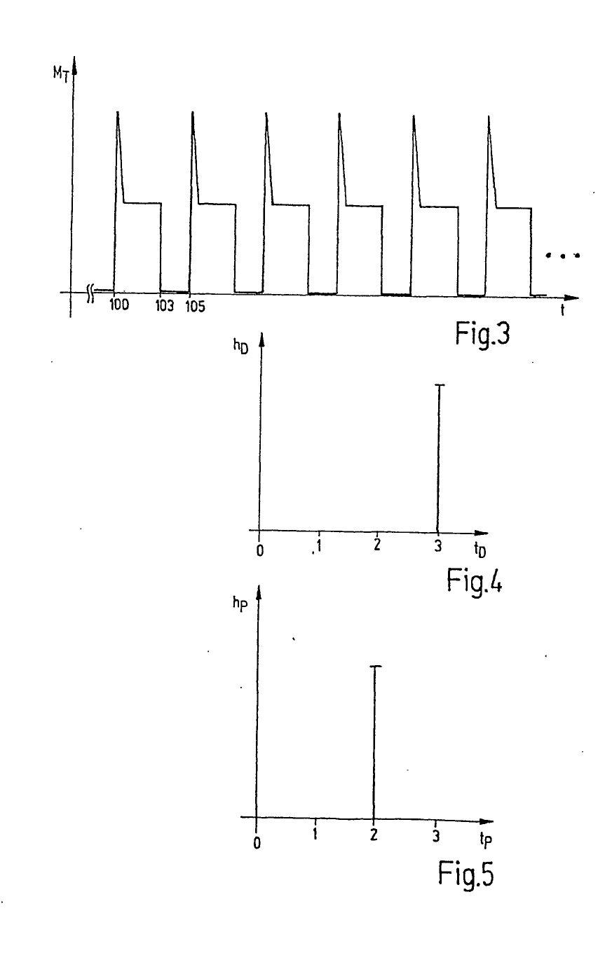

FIG. 3 shows a (theoretical) profile of the torque M_{T}, which is predetermined by the operator of the drive path 1, plotted against the time t. This shows that the operator assumes a load situation for the drive path 1 in which the drive path 1, in particular the motor 4, is switched on and off at regular intervals. A torque maximum occurs shortly after the time at which it is switched on. Apart from this, the torque load is largely constant. By way of example, a load profile such as this results in a specific temperature level, which may possibly fluctuate only slightly, in the drive path 1 as a function of the thermal conductivity and thermal capacity of the drive path 1 and of the associated environment. This in turn influences the aging, for example, of the winding insulation or of a lubricant, and thus influences the life and/or maintenance intervals for the drive path 1.

In the illustrated example, the operator of the drive path 1 has assumed that each switched-on duration of, for example, 3 minutes will be followed by a pause duration of 2 minutes. The associated probability distribution h₀ for the switched-on duration to thus has a single peak at 3 minutes, as is illustrated in FIG. 4. The associated probability distribution hp for the pause duration tₚ has a single peak at the pause duration of 2 minutes, as is illustrated in FIG. 5.

A manufacturer of the drive path 1 would, for example, use load data such as this as the basis for correspondingly designing the drive components, in particular the motor 4, the transmission 5 and/or the sensors 8, 9, for example with respect to insulating materials, bearing sizes, cooling measures, etc. The life and maintenance friendliness of the drive path 1 are influenced to a critical extent by whether the predetermined torque profile M_{T}(t) as illustrated in FIG. 3 also occurs during operation of the drive path 1.

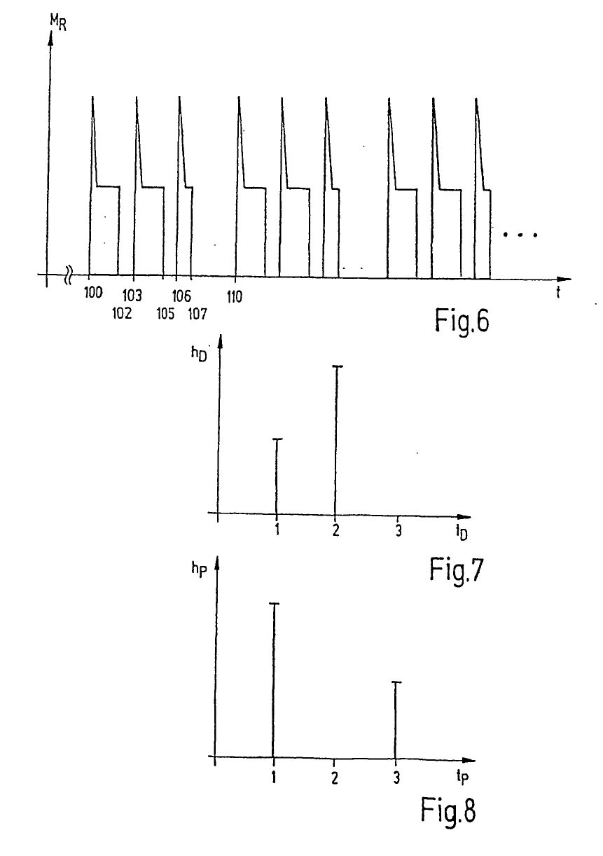

FIG. 6 shows the actual profile of the torque M_{R} plotted against the time t. There are significant changes in comparison to the torque profile M_{T}(t) as originally predetermined by the operator of the drive path 1. Thus, for example, the switched-on duration is not constant, but is 2 minutes in two thirds of the cases and is only 1 minute in one third of the cases. FIG. 7 shows a corresponding probability distribution h_{D} for the switched-on duration t_{D}.

The pauses between the switched-on durations are 1 minute in two thirds of the cases, and are 3 minutes in the remaining third of the cases. A corresponding probability distribution h_{T} for the pause duration t_{T} is illustrated in FIG. 8.

The actual torque profile M_{R} plotted against the time t shows, for example, a different temperature profile for the drive path 1. The motor is cooled down to a greater extent during the longer pauses, in order then to be heated up to a greater extent in the three switched-on durations which take place one after the other in groups. This leads to an increased alternating temperature load on the winding insulation. The manufacturer of the drive path 1 will attempt to compensate for this by using appropriately better-quality insulating materials in order to still ensure that the drive path 1 has a long life and has a high degree of maintenance friendliness, with long servicing intervals.

The differences that are illustrated in FIGS. 3 to 8 between a data record M_{T}(t) as predetermined by the operator of the drive path 1 and an actual data record M_{R}(t) which represents a real load and the actual load are illustrated, just by way of example, on the basis of the torque profile M plotted against the time t. Other data that are relevant to the drive path 1 may be recorded in a corresponding manner, for example the bearing forces, rotation speeds and air humidity of the environment, etc, that occur.

In addition to the sensors 8, 9 for the force/torque and rotation speed that are quoted in the exemplary embodiment, sensors for the tilting moment, bearing force, speed, acceleration, temperature, leakage, sealing, lubricant contamination, and wear, etc may be provided in addition or alternatively, depending on the application.

1-16 (canceled)

17. A method for optimization of the design of motor drive paths (1) having a computation system (3), with memory means (2) for calculation of parameters of drive components (4, 5) using a data record (6) which can be predetermined and which represents the load on the drive components, characterized in that the data record (6) which is used for the calculation of the parameters is recorded by means of appropriate sensors (8, 9), including actual, installed drive paths (1) which are in operation, and load data (7) which is transmitted (10) electronically to the computation system (3) is determined automatically.

18. The method as claimed in claim 17, wherein the computation system (3) and the drive path (1) which is in use are located at different points (17, 18), and in that the actual load data (7) is transmitted via a data network (16).

19. The method as claimed in claim 17, wherein the actual load data (7) is transmitted by a public data network.

20. The method as claimed in claim 17, wherein the actual load data (7) is transmitted by the Internet.

21. The method as claimed in claim 17, wherein the actual load data (7) is transmitted without the use of wires by a mobile telephone network or a mobile radio network.

22. The method as claimed in claim 17, wherein the representative data record (6) is determined automatically by linking the actual load data (7) to an original data record (25) which is already stored in the computation system.

23. The method as claimed in claim 22, wherein the actual load data (7) is linked (29) to the original data record (25) using a weighting function (28).

24. The method as claimed in claim 22, wherein the representative data record (6) is individualized (X) on the basis of the actual load data (7) which is used in order to determine this data record (6) automatically, in particular with regard to the operator, type, type of use and/or point of use of the associated drive path (1).

25. The method as claimed in claim 17, wherein the actual load data (7) is temporarily stored (12) on the drive path (1) which is in operation.

26. The method as claimed in claim 25, wherein the transmission of the temporarily stored (12) actual load data (7) is controlled by the computation system (3).

27. The method as claimed in claim 25, wherein the transmission of the temporarily stored (12) actual load data (7) is controlled by the drive path (1).

28. The method as claimed in claim 25, wherein the actual load data (7) can be read on the drive path (1).

29. The method as claimed in claim 17, wherein the drive path (1) has as its drive components at least one of (a) at least one motor (4), (b) at least one transmission (5) and (c) at least one sensor.

30. The method as claimed in claim 29, wherein the motor (4) is an electric motor.

31. The method as claimed in claim 17, wherein the sensors (8, 9) record the torque (Mₐ), the tilting moment, the bearing force, the speed and the temperature of at least one of the drive components (4, 5).

32. The method as claimed in claim 17, wherein the automatically determined data record (6) is transmitted (20, 23) electronically to the operator of the drive path (1).

33. The method as claimed in claim 17, wherein the automatically determined data record (6) is transmitted to the operator by a data network (16).

34. The method as claimed in claim 17, wherein the automatically determined data record (6) is transmitted to the operator by the Internet.
